(19) United States
(12) Patent Application Publication
(10) Pub. No.: US 2022/0004986 A1
(43) Pub. Date: Jan. 6, 2022

(54) LOGISTICS NODE TRACING METHOD AND APPARATUS

(71) Applicants: Shenzhen Academy of Inspection and Quarantine, Shenzhen (CN); Shenzhen Customs Information Center, Shenzhen (CN); Shenzhen Customs Animal and Plant Inspection and Quarantine Technology Center, Shenzhen (CN)

(72) Inventors: XIANYU BAO, Shenzhen (CN); Lixun CHENG, Shenzhen (CN); Wenli ZHENG, Shenzhen (CN); Yina CAI, Shenzhen (CN); Ruizhi HE, Shenzhen (CN); Heping LI, Shenzhen (CN); Tikang LU, Shenzhen (CN); Zhifeng QIN, Shenzhen (CN); Zhouxi RUAN, Shenzhen (CN)

(21) Appl. No.: 17/009,712

(22) Filed: Sep. 1, 2020

(30) Foreign Application Priority Data
Jul. 1, 2020 (CN) 202010622825.2

(51) Int. Cl. G06Q 10/08; G06Q 10/04; G06N 7/00

(52) U.S. Cl. CPC G06Q 10/08355; G06N 7/005; G06Q 10/047

(57) ABSTRACT

The present disclosure provides a logistics node tracing method and apparatus for finding a trace node among logistics nodes in a logistics chain network corresponding to a logistics unit. The method includes: obtaining chain network information of a logistics chain network corresponding to a logistics unit, and determining a target analysis domain and confidence node(s) of the logistics unit according to the chain network information; determining fast node(s) according to the chain network information, the target analysis domain, and a timeliness level of each of the logistics nodes in the logistics chain network; determining a predicted logistics route corresponding to the logistics unit according to the chain network information, the target analysis domain, and the confidence node(s); and determining the trace node corresponding to the logistics unit according to the fast node(s) and the predicted logistics route.

### CROSS REFERENCE TO RELATED APPLICATIONS

The present disclosure claims priority to Chinese Patent Application No. 202010622825.2, filed Jul. 1, 2020, which is hereby incorporated by reference herein as if set forth in its entirety.

### BACKGROUND

### 1. Technical Field

The present disclosure relates to logistics route prediction technology, and particularly to a logistics node tracing method and a logistics node tracing apparatus.

### 2. Description of Related Art

The logistics chain network refers a directed acyclic graph formed by nodes for representing all the elements of a logistics system that are related to transactions or other product related works (e.g., warehousing and transportation) and directed arrows each representing the circulation relationship of a logistics unit (e.g., a logistics item, logistics truck, or logistics personnel) between two nodes. The process of constructing the logistics chain network is the process of constructing the directed acyclic graph, that is, through a present circulation information data set of logistics units, a logistics chain network is constructed using the nodes on the flow routes and the flow order between nodes of all the logistics units.

The tracing of logistics units can be divided into discrete batch logistics unit tracing and continuous batch logistics unit tracing from the view of the flow method. The former is mainly to study the flow sequence of one or more batches of logistics units between the nodes in the logistics chain network, while the latter is mainly to study the process of splitting and mixing the logistics units. As to the discrete batch logistics unit tracing, the tracing methods based on tracing marks are currently mostly used, which mainly include barcode technology, radio frequency identification technology, and biometric technology.

However, in the current researches on the tracing of logistics units, a few of them have considered about how to use the existing incomplete data to realize the tracing of logistics units in the case that the chain of tracing information is broken and the information is incomplete.

In the current applications of tracing logistics units in the absence of tracing data, a logistics unit often has the same or similar flow route with other logistics units with smaller general dissimilarities. In the exiting methods for tracing logistics units using incomplete data chain, the distribution of the flow times of the logistics units between all the node pairs with the connection relationship with respect to the logistics chain network is used for modeling to obtain the flow time distribution model for the nodes and perform predictions, thereby calculating the predicted flow time on routes. However, in the exiting methods for tracing logistics units using incomplete data chain, there are problems of excessively large analysis domain, small model granularity, low reliability of the flow routes of logistics units which is incapable of meeting the analysis timeliness requirements of certain nodes, and the like.

### SUMMARY

In view of solving the above-mentioned problems, the present disclosure provides a logistics node tracing method and a logistics node tracing apparatus to overcome the problems or at least partially solve the problems as follows.

A logistics node tracing method for finding at least a trace node among logistics nodes in a logistics chain network corresponding to a logistics unit is provided. In which, the logistics chain network is composed of a plurality of logistics routes, and each of the logistics routes is composed of a plurality of logistics nodes connected in a single direction. The method includes steps of:

obtaining chain network information of the logistics chain network corresponding to the logistics unit, and determining a target analysis domain and one or more confidence nodes of the logistics unit according to the chain network information, wherein the chain network information comprises logistics node information of each of the logistics nodes;

determining one or more fast nodes according to the chain network information, the target analysis domain, and a timeliness level of each of the logistics nodes in the logistics chain network;

determining a predicted logistics route corresponding to the logistics unit according to the chain network information, the target analysis domain, and the one or more confidence nodes; and

determining the trace node corresponding to the logistics unit according to the one or more fast nodes and the predicted logistics route.

In an example, the step of determining the one or more fast nodes according to the chain network information, the target analysis domain and the timeliness level of each of the logistics nodes in the logistics chain network can include:

determining a first sub-chain network according to the chain network information and the target analysis domain; and

determining the one or more fast nodes according to the first sub-chain network and the timeliness level of each of the logistics nodes in the logistics chain network.

In an example, the step of determining the predicted logistics route corresponding to the logistics unit according to the chain network information, the target analysis domain, and the one or more confidence nodes can include:

determining a second sub-chain network according to the first sub-chain network and the fast node; and

determining the predicted logistics route according to the second sub-chain network and the one or more confidence nodes.

In an example, the step of determining the trace node corresponding to the logistics unit according to the one or more fast nodes and the predicted logistics route can include:

determining the logistics node located before the one or more fast nodes in the predicted logistics route as the trace node.

In an example, the step of determining the first sub-chain network according to the chain network information and the target analysis domain can include:

determining a node type of each of the logistics nodes in the logistics chain network according to the chain network information, where the node type includes a start node, an end node, a fork node, a forking start node, and a midway node; and

generating the first sub-chain network according to the start node, the end node, the fork node, and the forking start node.

In an example, the step of determining the fast node according to the first sub-chain network and the timeliness level of each of the logistics nodes in the logistics chain network can include:

determining the forking start node corresponding to the fork node with the highest timeliness level according to the timeliness level of each of the logistics nodes in the first sub-chain network, and setting the forking start node as a fast forking start node;

determining the fork node corresponding to the fast forking start node as the fast forking node, and generating a third sub-chain network according to the start node, the end node, and the fast forking node;

determining an expected time to move the logistics unit from the start node to the end node through each of the fast forking nodes in the third sub-chain network; and

setting the fast forking node corresponding to the minimum expected time as the fast node.

In an example, the step of determining the second sub-chain network according to the first sub-chain network and the fast node can include:

removing the fast forking start node and the fast forking node in the first sub-chain network; and

generating the second sub-chain network according to the remaining logistics nodes in the first sub-chain network.

In an example, the step of determining the predicted logistics route according to the second sub-chain network and the one or more confidence nodes can include:

determining the expected time to move the logistics unit from the start node to the end node through each of the forking nodes in the second sub-chain network; and

generating the predicted logistics route according to the expected time and the one or more confidence nodes.

In an example, the step of generating the predicted logistics route according to the expected time parameter and the one or more confidence nodes can include:

setting the logistics route with the largest number of confidence nodes as the predicted logistics route, in response to there being logistics routes with the same expected time; and

setting the logistics route with the minimum expected time as the predicted logistics route, in response to there being no logistics route with the same expected time.

Furthermore, a logistics node tracing apparatus for finding at least a trace node among logistics nodes in a logistics chain network corresponding to a logistics unit

In which, the logistics chain network is composed of a plurality of logistics routes, and each of the logistics routes is composed of a plurality of logistics nodes connected in a single direction. The apparatus includes: a memory, a processor, and a computer programs stored in the memory and executable on the processor, where the computer program include:

instructions for obtaining chain network information of the logistics chain network corresponding to the logistics unit, and determining a target analysis domain and one or more confidence node of the logistics unit according to the chain network information, wherein the chain network information comprises logistics node information of each of the logistics nodes;

instructions for determining one or more fast nodes according to the chain network information, the target analysis domain, and a timeliness level of each of the logistics nodes in the logistics chain network;

instructions for determining a predicted logistics route corresponding to the logistics unit according to the chain network information, the target analysis domain, and the one or more confidence nodes; and

instructions for determining the trace node corresponding to the logistics unit according to the one or more fast nodes and the predicted logistics route.

The embodiments of the present disclosure have the advantages as follows.

In the embodiment of the logistics node tracing method/apparatus, it obtains chain network information of the logistics chain network corresponding to the logistics unit, and determines a target analysis domain and one or more confidence nodes of the logistics unit according to the chain network information, where the chain network information includes logistics node information of each of the logistics nodes; determines one or more fast nodes according to the chain network information, the target analysis domain, and a timeliness level of each of the logistics nodes in the logistics chain network; determines a predicted logistics route corresponding to the logistics unit according to the chain network information, the target analysis domain, and the one or more confidence nodes; and determines the trace node corresponding to the logistics unit according to the one or more fast nodes and the predicted logistics route. According to the different timeliness requirements of the changeable nodes in the streamlined logistics chain network, the changeable nodes are divided into fast nodes and slow nodes, thereby constructing a fast and streamlined logistics chain network. In which, the route of the logistics unit is analyzed via the fast nodes, and the fast nodes at which the logistics unit passing through is determined first, then the complete flow route of the logistics unit is further determined, thereby improving the tracing efficiency. The confidence nodes are used as the basis for determining the tracing of the predicted logistics route among multiple possible flow routes for the logistics unit, thereby improving the tracing reliability on the logistics unit.

### BRIEF DESCRIPTION OF THE DRAWINGS

To describe the technical schemes in the embodiments of the present disclosure or in the prior art more clearly, the following briefly introduces the drawings required for the descriptions in the present disclosure. It should be understood that, the drawings in the following description merely show some embodiments of the present disclosure. For those skilled in the art, other drawings can be obtained according to the drawings without creative efforts.

FIG. 1 is a flow chart of an embodiment of a logistics node tracing method according to the present disclosure.

FIG. 2 is a schematic view of a logistics chain network of the logistics node tracing method of the embodiment of FIG. 1.

FIG. 3 is a schematic view of a first sub-chain network of the logistics node tracing method of the embodiment of FIG. 1.

FIG. 4 is a schematic view of a second sub-chain network of the logistics node tracing method of the embodiment of FIG. 1.

FIG. 5 is a schematic view of a third sub-chain network of the logistics node tracing method of the embodiment of FIG. 1.

FIG. 6 is a schematic block diagram of the structure of an embodiment of a logistics node tracing apparatus according to the present disclosure.

FIG. 7 is a schematic block diagram of the structure of an embodiment of a computing device according to the present disclosure.

### DETAILED DESCRIPTION

In order to make the objects, features and advantages of the present disclosure more obvious and easy to understand, the technical solutions of the present disclosure will be further described below with reference to the drawings and the embodiments. Apparently, the described embodiments are part of the embodiments of the present disclosure, not all of the embodiments. All other embodiments obtained by those skilled in the art based on the embodiments of the present disclosure without creative efforts are within the scope of the present disclosure.

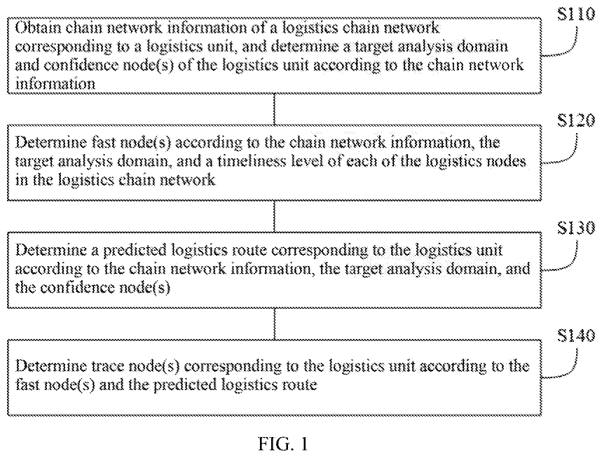

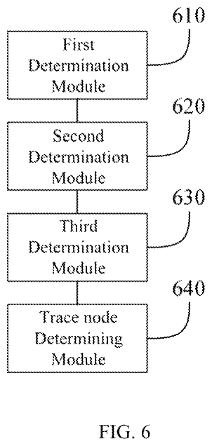

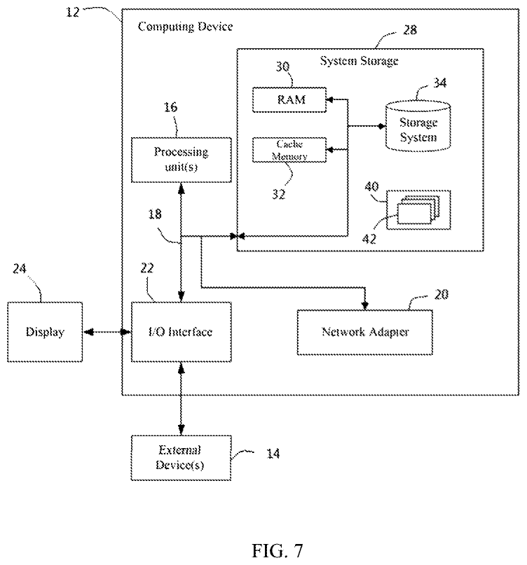

FIG. 1 is a flow chart of an embodiment of a logistics node tracing method according to the present disclosure. In this embodiment, a logistics node tracing method is provided. The method is for finding trace node(s) among logistics nodes in a logistics chain network corresponding to a logistics unit. In which, the logistics chain network is composed of a plurality of logistics routes, and each of the logistics routes is composed of a plurality of the logistics nodes connected in a single direction. The logistics unit is the objective to be traced, which can be an object or a person that moves on the logistics route, for example, a logistics item (e.g., a product or goods), a logistics truck, or a logistics personnel, and the like. The method is a computer-implemented method executable for a processor. In one embodiment, the method may be implemented through and applied to a logistics node tracing apparatus shown in FIG. 6 or implemented through and applied to a computing device shown in FIG. 7.

As shown in FIG. 1, the method includes the following steps.

S110: obtaining chain network information of the logistics chain network corresponding to the logistics unit, and determining a target analysis domain and confidence node(s) of the logistics unit according to the chain network information, where the chain network information includes logistics node information of each of the logistics nodes;

S120: determining fast node(s) according to the chain network information, the target analysis domain, and a timeliness level of each of the logistics nodes in the logistics chain network;

S130: determining a predicted logistics route corresponding to the logistics unit according to the chain network information, the target analysis domain, and the confidence node(s); and

S140: determining the trace node(s) corresponding to the logistics unit according to the fast node(s) and the predicted logistics route.

In this embodiments, it obtains chain network information of the logistics chain network corresponding to the logistics unit, and determines a target analysis domain and confidence node(s) of the logistics unit according to the chain network information, where the chain network information includes logistics node information of each of the logistics nodes; determines fast node(s) according to the chain network information, the target analysis domain, and a timeliness level of each of the logistics nodes in the logistics chain network; determines a predicted logistics route corresponding to the logistics unit according to the chain network information, the target analysis domain, and the confidence node(s); and determines the trace node(s) corresponding to the logistics unit according to the fast node(s) and the predicted logistics route. According to the different timeliness requirements of the changeable nodes in the streamlined logistics chain network, the changeable nodes are divided into fast nodes and slow nodes, thereby constructing a fast and streamlined logistics chain network. In which, the route of the logistics unit is analyzed via the fast nodes, and the fast nodes at which the logistics unit passing through is determined first, then the complete flow route of the logistics unit is further determined, thereby improving the tracing efficiency. The confidence nodes are used as the basis for determining the tracing of the predicted logistics route among multiple possible flow routes for the logistics unit, thereby improving the tracing reliability on the logistics unit.

The logistics node tracing method of this exemplary embodiment will be further explained as follows.

In step S110, the chain network information of the logistics chain network corresponding to the logistics unit(s) is obtained, and the target analysis domain and the confidence node(s) of the logistics unit(s) are determined according to the chain network information. In which, the obtained chain network information includes the logistics node information of each of the logistics nodes and connection relationships between the logistics nodes. In this embodiment, the logistics node information includes location information and a node type of the logistics node, where the node type can include, for example, a start node, an end node, a fork node, a forking start node, and a midway node.

In this embodiment, the chain network information is obtained from the logistics system. The chain network information is obtained in response to, for example, a request for determining trace nodes among the logistics nodes in the logistics chain network which is received from the logistics system. The logistics system includes a computer system coupled to the logistics chain network, where the logistics system can be incorporated with the logistics chain network and coupled to the logistics chain network through, for example, a system bus, or be independent from the logistics chain network and coupled to the logistics chain network through, for example, a network such as the Internet. In addition, the logistics system can further include sensors (e.g., radio frequency sensors, biometric sensors, and cameras) for detecting logistics units which can be installed at, for example, each logistics node. The target analysis domain is a group in a clustering result of an incomplete data clustering method (e.g., “the missing data imputation approach based on incomplete data clustering” (MIBOI) proposed by Wu, Sen et al.) performed on the logistics units (to be traced) to which the logistics units with missing tracing information belong to. It should be noted that, the target analysis domain is set differently according to different analysis situations. Taking the tracing of the logistics unit as an example, because there are nodes with high timeliness requirements in the process of tracing the logistics unit, the selection of fast nodes must be performed first. The logistics unit is traced to determine the nodes in the logistics chain network through which it passes and the order of passing. Generally, the larger the analysis domain, the longer the analysis time; otherwise, the smaller the analysis domain, the shorter the analysis time. Therefore, in order to meet the timeliness requirements of the determination of the fast nodes, the target analysis domain of the logistics unit must be reduced. At the same time, in order to solve the problem of multiple possible flow routes that may occur when further determining the complete flow route of the logistics unit after the fast nodes are determined, the confidence nodes need to be determined while generating the target analysis domain of the logistics unit. In which, each of the confidence nodes is a logistics node among the logistics nodes in the logistics chain network that has a confidence value of 1, where the confidence value is a value filled to an attribute of the logistics unit with missing tracing data which corresponds to each of the logistics nodes by an incomplete data clustering based missing data imputation method (e.g., the MIBOI).

As an example, the process of determining the target analysis domain and the confidence nodes of the logistics units (to be traced) is essentially a process of clustering incomplete data sets of the logistics units and filling in missing values. Among the clustering method for incomplete data, the method of the MIBOI proposed by Wu, Sen et al. can be used. That is, the logistics nodes of the logistics chain network node is introduced as a binary attribute of the logistics units, and the group to which the logistics units in the clustering result that have missing tracing information belongs to is taken as the target analysis domain of the logistics units, the data filling results are taken as confidence values of the nodes, and the node with the confidence value of 1 is the confidence node.

In the specific clustering process, each of all the logistics units to be traced is scanned at a time, starting from creating the first class for the first scanned logistics unit, and the merging of the scanned logistics unit with the class or the creation of a new class is performed for each of the logistics units in one scan.

For the created class, only the constraint tolerance set is retained, rather than retaining the information of all the logistics units. Whether to create a new class depends on a pre-specified upper limit u of the dissimilarity for constraint tolerance set. For every logistics unit scanned, find the class with the smallest dissimilarity for constraint tolerance set after its merging, and determine whether the smallest dissimilarity for constraint tolerance set is less than u. If so, it will be merged into the class; otherwise, a new class will be created. After the above-mentioned clustering is completed, find the class of the logistics unit with missing tracing data, and the class is the target analysis domain of the logistics unit.

Based on the clustering result, for each constraint tolerance attribute, if its tolerance value is not “*”, the value of “*” in the attribute of the logistics unit in the class is replaced with the above-mentioned tolerance value. The filled value is the confidence value of the node, and the node with the confidence value of 1 is the confidence node.

In step S120, the fast node(s) are determined according to the chain network information, the target analysis domain, and the timeliness level of each of the logistics nodes in the logistics chain network.

In one embodiment, step S120 can include the steps as follows.

Step S121 (not shown): determining a first sub-chain network according to the chain network information and the target analysis domain.

It should be noted that, the first sub-chain network is a chain network obtained by streamlining the logistics chain network, that is, a streamlined chain network composed of streamlined route(s) re-formed after removing midway nodes (i.e., the intermediate nodes in the logistics route) of each logistics route in the logistics chain network.

Thus, the first sub-chain network is capable of improving the timeliness of tracing the trace nodes in the process of tracing the logistics unit.

In one embodiment, step S121 can include the steps as follows.

Step S1211 (not shown): determining a node type of each of the logistics nodes in the logistics chain network according to the chain network information, where the node type includes a start node, an end node, a fork node, a forking start node, and a midway node.

Thus, by classifying each logistics node in the chain network according to the node types, non-important nodes can be efficiently filtered out, and the simpleness of the logistics chain network can be improved, thereby saving time for subsequent steps. In this embodiment, the node type of each of the logistics nodes is determined based on the node type in the logistics node information of the logistics node in the chain network information.

Step S1212 (not shown): generating the first sub-chain network according to the start node, the end node, the fork node, and the forking start node.

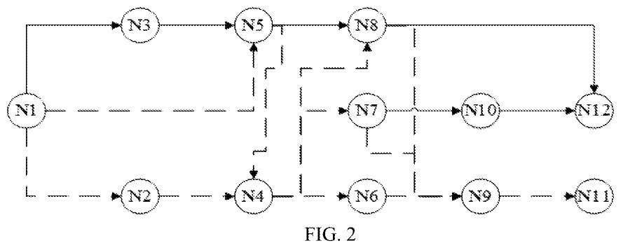

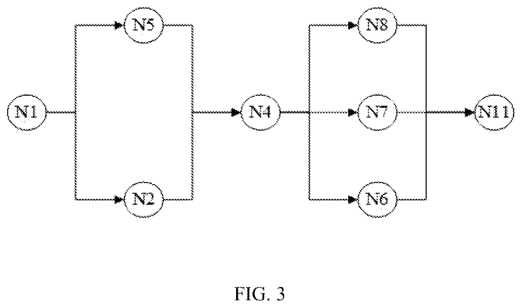

FIG. 2 is a schematic view of a logistics chain network of the logistics node tracing method of the embodiment of FIG. 1; and FIG. 3 is a schematic view of a first sub-chain network of the logistics node tracing method of the embodiment of FIG. 1. As shown in FIG. 2-FIG. 3, as an example, after obtaining the target analysis domain of the logistics unit, the original logistics chain network is streamlined. Assuming that the logistics chain network is as shown in FIG. 2, nodes N1-N11 represent the elements in the logistics chain network, and node Ni and node Nj are connected by a directed arrow to indicate that in this logistics chain network, there are relationships of logistics units such as transactions and transportations between node Ni and node Nj.

According to the flow route data of the logistics units in the target analysis domain of the logistics unit, the streamlined first sub-chain network can be obtained. In which, the analysis domain is a set of logistics units to be traced that have smaller general dissimilarity. Therefore, the streamlined logistics chain network generally includes routes with a few forks, for example, the chain network of FIG. 2 which is composed of the dotted arrows and their related nodes, where nodes N2, N5, N6, N7, and N8 are changeable nodes, and N1, N4, N9, and N11 are fixed nodes. The same nodes in all the flow routes are deleted, and only the start node as well as the fork node of each route and its forking start node are retained to obtain the streamlined logistics chain network, that is, the first sub-chain network as shown in FIG. 3.

Step S122 (not shown): determining the fast node(s) according to the first sub-chain network and the timeliness level of each of the logistics nodes in the logistics chain network.

It should be noted that, the determination of certain nodes have high timeliness requirements. For example, in the application of logistics unit tracing, in the case that a problematic product flows into a certain area, it means that a certain logistics node with inspection function has inspection flaws. Because of the urgency in identifying the logistics nodes with inspection functions that have inspection flaws and blocking the inspection flaws, it is necessary to quickly determine the logistics nodes with inspection functions at which the logistics units flow through, that is, priority must be given to the determination of certain logistics nodes with specific functions. At this time, the logistics nodes with the specific functions are the fast nodes.

In one embodiment, Step S122 can include the steps as follows.

Step S1221 (not shown): determining the forking start node corresponding to the fork node with the highest timeliness level according to the timeliness level of each of the logistics nodes in the first sub-chain network, and setting the forking start node as a fast forking start node.

Step S1222 (not shown): determining the fork node corresponding to the fast forking start node as the fast forking node, and generating a third sub-chain network according to the start node, the end node, and the fast forking node.

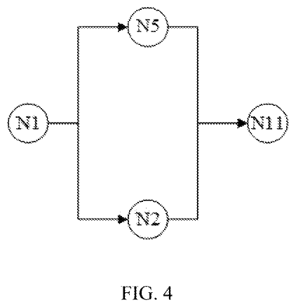

FIG. 4 is a schematic view of a second sub-chain network of the logistics node tracing method of the embodiment of FIG. 1. Referring to FIG. 3 and FIG. 4, as an example, assuming that in the first sub-chain network shown in FIG. 3, nodes N2 and N5 are the nodes with the highest timeliness requirement, that is, the fast nodes. It is necessary to quickly determine whether node N2 or node N5 is passed through by the logistics unit. Therefore, the first sub-chain network that has been streamlined once through the target analysis domain needs to be further streamlined to determine the fast nodes first. After deleting all the nodes in the logistics chain network that are within the target analysis domain except for the fast nodes, the starting node, and ending node, the further streamlined logistics chain network as shown in FIG. 4, namely the third sub-chain network can be obtained.

Thus, the scope of analysis can be minimized to quickly determine the fast nodes.

Step S1223 (not shown): determining an expected time to move the logistics unit from the start node to the end node through each of the fast forking nodes in the third sub-chain network.

As an example, the flow time t of the logistics unit between two nodes in the third sub-chain network is taken as a random variable, n time samples within the analysis domain are collected, and the sample interval is divided into k incompatible equidistant intervals, then the value of k can be determined by the empirical formula k=1.87(n−1)^{2/5} proposed by H. A. Sturges. In which, the sample interval refers to the difference between the maximum value and the minimum value of the n time samples collected. The number of samples within each interval is counted, and the accumulative frequency of each interval is calculated, so as to initially predict the time distribution of the logistics units.

The maximum likelihood estimation is used to solve the time distribution parameter of the logistics unit. Taking the estimation of the flow time distribution of the logistics unit between node N1 and node N5 in FIG. 2 as an example, assuming that the random variable of the flow time between the two nodes is T, and the variable distribution in the initial estimation is a normal distribution, the maximum likelihood estimation can be used to solve the normal distribution parameter. The probability density function is f(t, μ, σ), and the time sample values obtained are t₁, t₂, . . . , and tₙ, then the value of the join density function is Πᵢ₌₁ⁿf(tᵢ, μ, σ) when the value of the random point (T₁, T₂, . . . Tₙ) is (t₁, t₂, . . . tₙ). Therefore, according to the maximum likelihood estimation, the values of μ and a should be chosen to maximize the probability. The likelihood function is as follows:

$$\begin{matrix}L ( μ , {σ}^{2} ) = {\prod }_{i = 1}^{n} f ( {t}_{i} , μ , σ ) \\ = {\prod }_{i = 1}^{n} \frac{1}{\sqrt{2 π} σ} {e}^{- \frac{{ }_{{( {t}_{i} - μ )}^{2}}}{2 {σ}^{2}}} \\ = {( 2 π {σ}^{2} )}^{- \frac{n}{2} {e}^{- \frac{{\sum }_{i = 1}^{n} {( {t}_{i} - μ )}^{2}}{2 {σ}^{2}}}}\end{matrix} ; \qquad ( 1 )$$

in which, the likelihood function of formula (1) is:

$$l ( μ , {σ}^{2} ) = - \frac{n}{2} ln ( 2 π {σ}^{2} ) - \frac{1}{2 {σ}^{2}} {\sum }_{i = 1}^{n} {( {t}_{i} - μ )}^{2} ; \qquad ( 2 )$$

the partial derivatives of l(μ, σ2) with respect to μ and σ², respectively, are calculated, and all of them are set to 0, then the following likelihood equations will be obtained:

$$\{ \begin{matrix}\frac{\partial l ( μ , {σ}^{2} )}{\partial μ} = \frac{1}{{σ}^{2}} {\sum }_{i = 1}^{n} {( {t}_{i} - μ )}^{2} = 0 \\ \frac{\partial l ( μ , {σ}^{2} )}{\partial {σ}^{2}} = - \frac{n}{2 {σ}^{2}} + \frac{1}{2 {σ}^{4}} {\sum }_{i = 1}^{n} {( {t}_{i} - μ )}^{2} = 0\end{matrix} ; \qquad ( 3 )$$

by solving the likelihood equations, it obtains:

$$\hat{μ} = \overline{x} , \hat{σ} = \frac{1}{n} {\sum }_{i = 1}^{n} {( {x}_{i} - \overline{x} )}^{2} ; \qquad ( 4 )$$

the distribution parameters μ and σ are solved so as to determine the distribution of the flow time of the logistics unit between node N1 and node N5.

By using the above-mentioned method, the distribution of the flow time of the logistics unit between node N1 and node N5, node N1 and node N2, node N5 and node N11, and node N2 and node N11 can be respectively obtained, and the expected flow time of the logistics unit between two nodes can be solved by:

$${\int }_{- ∞}^{+ ∞} \frac{x}{\sqrt{2 π} σ} {e}^{- \frac{{( x - μ )}^{2}}{2 {σ}^{2}}} \\ = μ \\ = \overline{x} . \qquad ( 5 )$$

Therefore, the expected time of each logistics route can be obtained, and the expected time of one logistics route is the sum of the expected times of each route between nodes. For example, the expected route time of the route N1→N5→N11 is E_{N}_{₁}_{→N}_{₅}+E_{N}_{₅}_{→N}_{₁₁}.

Step S1224 (not shown): setting the fast forking node corresponding to the minimum expected time as the fast node.

Referring to 4, as an example, after obtaining the expected times of all the logistics routes in the third sub-chain network through the foregoing steps, a reference route is selected according to the objective of minimizing the preset time difference between the logistics unit and the expected time of each logistics route, the fast forking node (N2 or N5) passed on the route is the fast node passed by the logistics unit.

In step S130, the predicted logistics route corresponding to the logistics unit is determined according to the chain network information, the target analysis domain, and the confidence node(s).

It should be noted that, after the fast nodes that the logistics unit passes in the logistics chain network are obtained through the foregoing steps, the complete route of the logistics route is further predicted.

The predicted logistics route can be used to further determine the node where a hazard problem of the logistics unit is introduced, and be used to trace the source of a safety problem of the logistics unit, and can also be used to recommend a logistics route for the logistics unit to be transported.

In one embodiment, step S130 can include the steps as follows.

Step S131 (not shown): determining a second sub-chain network according to the first sub-chain network and the fast node(s).

In one embodiment, Step S131 can include the steps as follows.

Step S1311 (not shown): removing the fast forking start node and the fast forking node in the first sub-chain network.

Step S1312 (not shown): generating the second sub-chain network according to the remaining logistics nodes in the first sub-chain network.

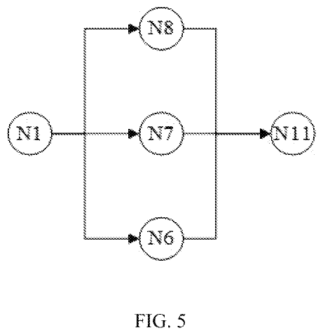

FIG. 5 is a schematic view of a third sub-chain network of the logistics node tracing method of the embodiment of FIG. 1. As shown in FIG. 5, it should be noted that since the fast nodes that the logistics unit passes through have been determined through the foregoing steps, the passed fast nodes in the logistics chain network that are within the analysis domain can be taken as fixed nodes to be removed while other changeable nods are remained unchanged, and the second sub-chain network shown in FIG. 5 is obtained.

Step S132 (not shown): determining the predicted logistics route according to the second sub-chain network and the confidence node(s).

In one embodiment, Step S132 can include the steps as follows.

Step S1321 (not shown): determining the expected time to move the logistics unit from the start node to the end node through each of the forking nodes in the second sub-chain network.

It should be noted that, the calculation method of the expected time performed in this step is the same as the calculation method of the expected time of the route N1→N5 in the forgoing step. For the specific process, refer to the description of the foregoing step, which will not be repeated herein.

Step S1322 (not shown): generating the predicted logistics route according to the expected time and the confidence node(s).

As a result, the effectiveness of the determined predicted logistics route can be improved, and the prediction efficiency can be improved.

In one embodiment, Step S1322 can include the steps as follows.

Step S13221 (not shown): setting the logistics route with the largest number of confidence nodes as the predicted logistics route, in response to there being logistics routes with the same expected time; and

Step S13222 (not shown): setting the logistics route with the minimum expected time as the predicted logistics route, in response to there being no logistics route with the same expected time.

Referring to FIG. 5, as an example, after calculating the flow time distribution of the logistics unit between node N1 and node N8, node N1 and node N6, node N1 and node N7, node N8 and node N11, node N6 and node N11, and node N7 and node N11, respectively, the expected times of three routes are obtained. Since there may be multiple possible routes in the determination of the route of the other changeable nodes except the fast nodes, a preset route selection threshold γ is set to take all the routes with the expected time difference from the expected time of the reference route of less than γ as possible routes.

If a plurality of possible routes are solved, the confidence nodes are used as the basis for the prediction of the route of the logistics unit, and the route including more confidence nodes is regarded as the flow route of the logistics unit. After determining the fast nodes of the flow of the logistics unit and other changeable nodes, by using the data of the fixed nodes obtained by counting in the target analysis domain of the logistics unit, the complete predicted logistics route of the logistics unit in the logistics chain network can be obtained.

In step S140, the trace node(s) corresponding to the logistics unit is determined according to the fast node(s) and the predicted logistics route.

In this embodiment, the trace node is provided to the logistics system by, for example, transmitting a response for the request for determining the trace nodes among the logistics nodes in the logistics chain network which includes the trace node to the logistics system. In one embodiment, step S140 can include the steps as follows.

Step S141 (not shown): determining the logistics node located before the fast node(s) in the predicted logistics route as the trace node(s).

The logistics node before each fast node is determined as a trace node. The trace node is a (suggested) node for an investigator to investigate in the case that, for example, there is a logistics node with inspection flaw in the logistics chain network. Thus, the number of the logistics nodes for the investigator to investigate can be reduced, so as to improve the efficiency and accuracy of the tracing of the logistics unit.

In this embodiment, it addresses the problems of excessively large analysis domain, small model granularity, low reliability of the flow routes of logistics units which is incapable of meeting the analysis timeliness requirements of certain nodes, and the like in the conventional methods for tracing logistics units using incomplete data chain by dividing the nodes in the chain network into changeable nodes and fixed nodes to analyze the changeable nodes. Furthermore, the changeable nodes are divided into the fast nodes and the slow nodes according to the different analysis timeliness requirements of the changeable nodes. It introduces the attributes of the nodes of the logistics chain network into the data sets of the logistics units to regard as incomplete data sets. The problem of predicting the flow route of logistics units is taken as the problem of filling missing data in the incomplete data sets, and the incomplete data clustering method is introduced, and then the clustering result is taken as the target analysis domain of the logistics unit while the result of filling the missing data is taken as the confidence value of the node, thereby determining the confidence nodes. The streamlined logistics chain network (i.e., the first sub-chain network) is determined through the target analysis domain of the logistics unit, and then the streamlined logistics chain network (i.e., the second sub-chain network) is further determined. On this basis, the logistics node tracing method using incomplete data chain is used to quickly determine the fast nodes through which the logistics unit flows first, and further determine the changeable node through which the logistics unit flows. If there are a plurality of possible routes, the confidence nodes are introduced to distinguish the flow route, thereby increasing the reliability of the prediction of the flow route of the logistics unit. The analysis domain is limited to the data set of the logistics unit that has smaller general dissimilarity to the logistics unit with missing tracing data, so as to narrow the analysis domain of the methods for tracing logistics units using incomplete data chain and exclude irrelevant nodes and data. The time distribution model of the logistics unit is solved based on the streamlined logistics chain network, which increases the model granularity and reduces the complexity of the calculation process.

Referring to FIG. 2-FIG. 5, in this embodiment, in order to verify the fast nodes obtained using the logistics chain network that the logistics unit flows through, and to further determine the effectiveness of the logistics unit flow route, it takes the logistics chain network shown in FIG. 2 as an example to perform simulation and analysis. Assuming that the logistics chain network constructed based on the historical data set of logistics unit is as shown in FIG. 2, and it is known that a certain logistics unit starts from the end node N1 and flows between the subsequent nodes N2-N12, where the tracing data of the logistics unit is lost and its flow route has to be determined.

The nodes in the logistics chain network are introduced as binary attributes of the logistics unit. In the historical data set of a logistics unit, if the logistics unit passes through node N2, the value of its binary attribute N2 is 1. As an example, the tracing data of logistics unit A (not shown) is missing, that is, the values of the attributes of the attributes of the nodes N1-N12 are unknown. The clustering method based on incomplete data is used to cluster the historical data set of the logistics unit. Assuming that there are 100 logistics units of the class of including the logistics unit A after clustering, and the filled values of the attribute of the nodes N1-N12 are (1, 0, 0, 1, 1, 1, 1, 0, 1, 0, 1, 0), then the flow data of the 100 logistics units are analyzed to obtain the route involved in its flow is as shown by the dotted arrow and the corresponding node in FIG. 2, that is, the first sub-chain network shown in FIG. 3.

Assuming that the nodes N2 and N5 are known as fast nodes, according to the above-mentioned method, the nodes N4, N6, N7, and N8 and the corresponding directed edges are deleted to obtain the second sub-chain network as shown in FIG. 4.

In the circulation relationship of the logistics unit between the nodes, the flow time of the logistics unit between two nodes, for example, the delivery time of the logistics unit between two nodes directly connected with a directed edge, can be approximated as floating around a certain value. That is, the flow time can be regarded as having a normal distribution. If it is analyzed as having other distribution manners based on actual condition, it can also be predicted according to the following steps.

Taking the prediction of the time distribution function f(t_{1, 2}) between node N1 and node N2 as an example, the time distribution characteristic between nodes are solved so as to obtain the expected time of the route, thereby determining the fast nodes through which the logistics unit flows. The flow time data (in the case that the number of the logistics units of the class including the logistics unit A is too large after clustering, an appropriate number of logistics units can be selected as random samples) of the obtained 100 logistics units is collected to take as random samples t₁, t₂, t₃, . . . , and t₁₀₀, where the unit is h. The sample data is divided into 12 groups to divide the overall value range into 12 mutually incompatible intervals, and a sample frequency distribution table as shown in Table 1 is established.

TABLE 1

| Group | Values in | Number of | | Accumulative |
|---|---|---|---|---|
| Numbers | Group | Frequencies | Frequencies | Frequencies |
| 1 | 3.2215 | 1 | 0.01 | 0.01 |
| 2 | 3.3937 | 3 | 0.03 | 0.04 |
| 3 | 3.5124 | 6 | 0.06 | 0.10 |
| 4 | 3.6668 | 9 | 0.09 | 0.19 |
| 5 | 3.7817 | 14 | 0.14 | 0.33 |
| 6 | 3.9001 | 15 | 0.15 | 0.48 |
| 7 | 4.0223 | 18 | 0.18 | 0.66 |
| 8 | 4.1518 | 14 | 0.14 | 0.80 |
| 9 | 4.2624 | 8 | 0.08 | 0.88 |
| 10 | 4.3730 | 6 | 0.06 | 0.94 |
| 11 | 4.4908 | 3 | 0.03 | 0.97 |
| 12 | 4.5855 | 3 | 0.03 | 1.00 |

The frequency distribution table can be used to predict the distribution of variables. It is determined from Table 1 that the time distribution between nodes N1 and N2 obeys the normal distribution, and the expected value is around 4. After calculation, the maximum likelihood predicted values of the normal distributed parameters μ and σ are μ=3.9702 and σ=0.3102, respectively. Therefore, the distribution of the flow time of the logistics unit between node N1 and node N2 is N(3.97, 0.10). Similarly, the distribution of the flow time of the logistics unit between each node is calculated as shown in Table 2.

TABLE 2

| Departure Node | Arrival Node | Time Distribution |
|---|---|---|
| N1 | N5 | N (3.23, 0.07) |
| N1 | N2 | N (3.97, 0.10) |
| N5 | N11 | N (14.05, 0.06) |
| N2 | N11 | N (15.88, 0.09) |

The calculated expected flow times of the two routes in the second sub-chain network are as shown in Table 3.

TABLE 3

| Routes | Expected Flow Times |
|---|---|
| N1→N5→N11 | 17.28 |
| N1→N2→N11 | 19.85 |

Assuming that the preset delivery time and receiving time of the logistics unit with missing tracing data are known, the difference is 19.50 h. The difference between the route N1→N2→N11 and the preset time is 0.35 h, and the time difference between the route N1→N5→N11 and the preset time is 2.22 h. According to the forgoing analysis, the fast node passed by the target analysis domain is N2.

After determining the fast nodes, it needs to further determine the complete flow route of the logistics unit. According to the above-mentioned method, the distribution of the flow time of the logistics units between the nodes connected with directed edges in the third sub-chain network in FIG. 5 is as shown in Table 4.

TABLE 4

| Departure Node | Arrival Node | Time Distribution |
|---|---|---|
| N1 | N8 | N (9.52, 0.09) |
| N1 | N7 | N (10.43, 0.09) |
| N1 | N6 | N (11.05, 0.08) |
| N8 | N11 | N (6.24, 0.07) |
| N7 | N11 | N (5.45, 0.11) |
| N6 | N11 | N (6.88, 0.12) |

Similarly, the calculated expected flow times of the three routes can be as shown in Table 5.

TABLE 5

| Routes | Expected Flow Times |
|---|---|
| N1→N8→N11 | 15.78 |
| N1→N7→N11 | 15.88 |
| N1→N6→N11 | 17.93 |

In the first sub-chain network, because there are generally more changeable nodes, and the route branches generated by the changeable nodes are also more, so the difference between the expected flow time of the route and the preset time is directly used as the basis of determination, which is easy to produce larger errors and leads to low reliability of the prediction of the route of the logistics unit. Therefore, when determining the changeable nodes, a threshold γ is set in advance. In practical applications, the value of γ is set according to the order of magnitude of the flow time between two nodes, which is recommended to set to 10%-20% of the average value of the flow time of the logistics unit between nodes. In the simulation analysis, the expected flow time between two nodes is about 4 h, and the value of γ can be set to 0.5 h. The routes with the difference between the expected the flow time of the route and the preset time less than γ are all possible routes. If the difference between the delivery time and the receiving time of the logistics unit with missing tracing data is 16.2 h, the routes N1→N8→N11 and N1→N7→N11 are all possible routes. If there are a plurality of possible routes, the confidence nodes are used as the basis for determining the route. The confidence values of the node attribute of the found logistics unit with missing tracing data is (1, 0, 0, 1, 1, 1, 1, 1, 0, 1, 0, 1, 0), it can be seen that the confidence value of node N7 is 1 and the confidence value of node N8 is 0, which indicates that node N7 is a confidence node, and a route including more confidence nodes has a higher reliability. Therefore, the flow route of the logistics unit is N1→N7→N11.

After the forgoing analysis, the fast nodes and the changeable nodes that the logistics units flow through in the streamlined logistics chain network are respectively determined, and by using them together with the fixed node information, the complete flow route of the logistics unit can be determined as: N1→N2→N4→N7→N9→N11.

In which, since node N2 is a fast node, the trace node can be node N1 and node N2.

As for a device embodiment, since it is basically similar to the method embodiment, the description as follows will be relatively simple. For related parts, please refer to the description of the method embodiment.

FIG. 6 is a schematic block diagram of the structure of an embodiment of a logistics node tracing apparatus according to the present disclosure. In this embodiment, a logistics node tracing apparatus (device) is provided. The apparatus is for finding trace node(s) among logistics nodes in a logistics chain network corresponding to a logistics unit. In which, the logistics chain network is composed of a plurality of logistics routes, and each of the logistics routes is composed of a plurality of the logistics nodes connected in a single direction. In one embodiment, the apparatus may be implemented through and applied to a computing device shown in FIG. 7 or be the computing device itself.

As shown in FIG. 6, the apparatus includes:

a first determination module 610 configured to obtain chain network information of the logistics chain network corresponding to the logistics unit, and determine a target analysis domain and confidence node(s) of the logistics unit according to the chain network information, where the chain network information includes logistics node information of each of the logistics nodes;

a second determination module 620 configured to determine fast node(s) according to the chain network information, the target analysis domain, and a timeliness level of each of the logistics nodes in the logistics chain network; and

a third determination module 630 configured to determine a predicted logistics route corresponding to the logistics unit according to the chain network information, the target analysis domain, and the confidence node(s).

a trace node determining module 640 configured to determine the trace node(s) corresponding to the logistics unit according to the fast node(s) and the predicted logistics route, and provide the trace node(s) to the logistics system.

In one embodiment, the second determination module 620 includes:

a first sub-chain network determining sub-module configured to determine a first sub-chain network according to the chain network information and the target analysis domain; and

a fast node determining sub-module configured to determine the fast node(s) according to the first sub-chain network and the timeliness level of each of the logistics nodes in the logistics chain network.

In one embodiment, the third determination module 630 includes:

a second sub-chain network determining sub-module configured to determine a second sub-chain network according to the first sub-chain network and the fast node(s); and

a predicted logistics route determining sub-module configured to determine the predicted logistics route according to the second sub-chain network and the confidence node(s).

In one embodiment, the trace node determining module 640 includes:

a trace node determining sub-module configured to determine the logistics node located before the fast node(s) in the predicted logistics route as the trace node.

In one embodiment, the first sub-chain network determining sub-module includes:

a node type determining sub-module configured to determine a node type of each of the logistics nodes in the logistics chain network according to the chain network information, where the node type includes a start node, an end node, a fork node, a forking start node, and a midway node; and

a first sub-chain network generating sub-module configured to generate the first sub-chain network according to the start node, the end node, the fork node, and the forking start node.

In one embodiment, the fast node determining submodule includes:

a fast forking start node determining submodule configured to determine the forking start node corresponding to the fork node with the highest timeliness level according to the timeliness level of each of the logistics nodes in the first sub-chain network, and setting the forking start node as a fast forking start node;

a fast forking node determining submodule configured to determining the fork node corresponding to the fast forking start node as the fast forking node, and generating a third sub-chain network according to the start node, the end node, and the fast forking node;

a first expected time determining sub-module configured to determine an expected time to move the logistics unit from the start node to the end node through each of the fast forking nodes in the third sub-chain network; and

a fast node setting sub-module configured to set the fast forking node corresponding to the minimum expected time as the fast node.

In one embodiment, the second sub-chain network determining sub-module includes:

a fast forking start node and fast forking node removal sub-module configured to remove the fast forking start node and the fast forking node in the first sub-chain network; and

a second sub-chain network generating sub-module configured to generate the second sub-chain network according to the remaining logistics nodes in the first sub-chain network.

In one embodiment, the predicted logistics route determining sub-module includes:

a second expected time determining sub-module configured to determine the expected time to move the logistics unit from the start node to the end node through each of the forking nodes in the second sub-chain network; and

a predicted logistics route generating sub-module configured to generate the predicted logistics route according to the expected time and the confidence node(s).

In one embodiment, the predicted logistics route generating sub-module includes:

a first predicted logistics route setting sub-module configured to set the logistics route with the largest number of confidence nodes as the predicted logistics route, in response to there being logistics routes with the same expected time; and

a second predicted logistics route setting sub-module configured to set the logistics route with the minimum expected time as the predicted logistics route, in response to there being no logistics route with the same expected time.

In this embodiment, each of the above-mentioned modules/units is implemented in the form of software, which can be computer program(s) stored in a memory of the logistics node tracing apparatus and include instructions executable on a processor of the logistics node tracing apparatus. In other embodiments, each of the above-mentioned modules/units may be implemented in the form of hardware (e.g., a circuit of the logistics node tracing apparatus which is coupled to the processor of the logistics node tracing apparatus) or a combination of hardware and software (e.g., a circuit with a single chip microcomputer).

FIG. 7 is a schematic block diagram of the structure of an embodiment of a computing device according to the present disclosure. In this embodiment, a computing device 12 is provided. The computing device 12 is for predicting a logistics route for a logistics unit in a logistics chain network of a logistics system. In which, the logistics chain network is composed of a plurality of logistics routes, and each of the logistics routes is composed of a plurality of logistics nodes connected in a single direction. The computing device 12 is coupled to the logistics system through, for example, a system bus (e.g., an ISA bus) or a network (e.g., the Internet). In one embodiment, the computing device 12 may include the logistics node tracing apparatus shown in FIG. 7 or be the logistics node tracing apparatus itself.

As shown in FIG. 7, the above-mentioned computing device 12 is in the form of a general-purpose computing device. The computing device 12 may include, but are not limited to one or more processors or processing units 16, a system storage 28, and a bus 18 connecting different system components (including the system storage 28 and the one or more processing units 16).

The bus 18 may include a memory bus or a memory controller, a peripheral bus, a graphics acceleration port or processor, or a local bus using one or more bus structures. The bus 18 may include one or more types of bus with different structures, for example, industry standard architecture (ISA) bus, microchannel architecture (MAC) bus, enhanced ISA bus, audio and video electronics standards association (VESA) local bus, and peripheral component interconnect (PCI) bus.

The computing device 12 typically includes a variety of computer system readable media. These media can be any media that can be accessed by the computing device 12, including volatile and non-volatile media as well as removable and non-removable media.

The system storage 28 may include a computer system readable medium in the form of volatile memory such as random access memory (RAM) 30 and/or cache memory 32. The computing device 12 may further include other removable/non-removable and volatile/nonvolatile computer system storage media. As an example, the storage system 34 may be used to read and write non-removable, non-volatile magnetic media (generally referred to as hard drive). Although not shown in FIG. 7, a disk drive for reading and writing removable non-volatile disks (e.g., floppy disks) and an optical drive for reading and writing removable non-volatile optical disks (for example, CD-ROMs, DVD-ROMs, or other optical media) can be provided. In these cases, each drive can be connected to the bus 18 through one or more data medium interfaces. The system storage 28 may include at least one program product, and the program product has a set (e.g., at least one) of program modules 42 configured to perform the functions of the embodiments of the present disclosure.

A program/utility tool 40 have a set (at least one) of program module 42 which may be stored in, for example, a memory. The program module 42 can include, but is not limited to, an operating system, one or more application programs, and other program modules and program data, and each or some combinations of these examples may include the implementation of a network environment. The program module 42 generally executes the functions and/or methods in the embodiments described in the present disclosure.

The computing device 12 may also communicate with one or more external devices 14 (e.g., keyboards, pointing devices, a display 24, and cameras), and may also communicate with one or more devices that enable users to interact with the computing device 12, and/ or communicate with any device (e.g., a network card and a modem) that enables the computing device 12 to communicate with one or more other computing devices. This communication can be performed through an input/output (I/O) interface 22. In addition, the computing device 12 may also communicate with one or more networks (for example, a local area network (LAN)), a wide area network (WAN), and/or a public network (e.g., the Internet) through a network adapter 20. As shown in FIG. 7, the network adapter 20 communicates with other modules of the computing device 12 through the bus 18. It should be understood that, although not shown in FIG. 7, other hardware and/or software modules including, but not limited to microcode, a device driver, a redundant processing unit 16, an external disk drive array, a RAID system, a tape drive, and a data backup storage system 34 can be used in conjunction with the computing device 12.

The processing unit 16 executes the programs stored in the system storage 28 so as to execute various functional applications and data processing such as implementing the above-mentioned logistics node tracing method provided by the embodiments of the present disclosure.

That is, when the above-mentioned processing unit 16 executes the above-mentioned program, it realizes: obtaining chain network information of a logistics chain network corresponding to a logistics unit, and determining a target analysis domain and confidence node(s) of the logistics unit according to the chain network information; determining fast node(s) according to the chain network information, the target analysis domain, and a timeliness level of each of the logistics nodes in the logistics chain network; determining a predicted logistics route corresponding to the logistics unit according to the chain network information, the target analysis domain, and the confidence node(s); and determining the trace node corresponding to the logistics unit according to the fast node(s) and the predicted logistics route.

In one embodiment, the present disclosure also provides a computer-readable storage medium stored with computer program(s), and when the program(s) are executed by a processor, the above-mentioned logistics node tracing method provided by the embodiments of the present disclosure is implemented.

That is, when the program is executed by the processor, it realizes: obtaining chain network information of a logistics chain network corresponding to a logistics unit, and determining a target analysis domain and confidence node(s) of the logistics unit according to the chain network information; determining fast node(s) according to the chain network information, the target analysis domain, and a timeliness level of each of the logistics nodes in the logistics chain network; determining a predicted logistics route corresponding to the logistics unit according to the chain network information, the target analysis domain, and the confidence node(s); and determining the trace node corresponding to the logistics unit according to the fast node(s) and the predicted logistics route.

Any combination of one or more computer-readable media may be used. The computer-readable medium may be a computer-readable signal medium or a computer-readable storage medium. The computer-readable storage medium may be, but not limited to, an electrical, magnetic, optical, electromagnetic, infrared, or semiconductor system, device, or component, or any combination of the above. As an example, the computer-readable storage media include: an electrical connection with one or more wires, a portable computer disk, a hard disk, a random access memory (RAM), a read-only memory (ROM), an erasable programmable read-only memory (EPOM), a flash, an optical fiber, a portable compact disk read-only memory (CD-ROM), an optical storage device, a magnetic storage device, or any suitable combination of the above. In the present disclosure, the computer-readable storage medium can be any tangible medium that contains or stores programs, and the programs can be used by or in combination with an instruction execution system, device, or component.

The computer-readable signal medium may include a data signal propagated in a baseband or as a part of a carrier wave, where computer-readable program codes are carried therein. The propagated data signal can use many forms including, but not limited to electromagnetic signals, optical signals, or any suitable combination of the foregoing. The computer-readable signal medium may also be any computer-readable medium other than the computer-readable storage medium. The computer-readable medium may send, propagate or transmit the program for use by or in combination with an instruction execution system, apparatus, or component.

The computer program codes for performing the operations of the present disclosure can be composed in one or more programming languages or a combination thereof. The above-mentioned programming languages may include object-oriented programming languages such as Java, Smalltalk, C++, and also include conventional procedural programming language such as C programming language or similar programming language. The program code can be executed entirely on the computer of a user, partly on the computer of the user, executed as an independent software package, executed partly on the computer of the use and partly on a remote computer, or entirely executed on the remote computer or server. In the case involving a remote computer, the remote computer can be connected to the computer of the user through any kind of network including a LAN or a WAN, or can be connected to an external computer (for example, connecting via the Internet provided by an Internet service provider). Each embodiment in the present disclosure is described in a progressive manner, and each embodiment focuses on the differences from other embodiments, hence the same or similar parts between the embodiments can be referred to each other.

Although the preferred embodiments of the present disclosure have been described, those skilled in the art can make additional changes and modifications to these embodiments without creative efforts once they learn of the basic creative concepts. Therefore, the appended claims are intended to be interpreted as including the preferred embodiments and all changes and modifications within the scope of the embodiments of the present disclosure.

Finally, it should be noted that in the present disclosure, the relational terms such as first and second are only used to distinguish one entity or operation from another entity or operation, and do not necessarily require or imply that there is any such actual relationship or order between these entities or operations. Moreover, the terms “include”, “comprise” or any other variants thereof are intended to cover non-exclusive inclusion, so that a process, method, object or terminal device including a series of elements not only includes those elements, but also includes other elements that are not explicitly listed, or also include elements inherent to the process, method, object or terminal device. If there are no more restrictions, an element defined by the sentence “including a(n) . . . ” does not exclude the existence of other same elements in the process, method, object or terminal device including the element.

The logistics node tracing method and the logistics node tracing apparatus provided by the present disclosure are described in detail above. Embodiments are used in the present disclosure to illustrate the principle and implementation of the present disclosure. The descriptions of the forgoing embodiment are only used to help understand the technical schemes of the present disclosure and their core ideas. At the same time, for those skilled in the art, according to the ideas of the present disclosure, there will be changes in the specific implementation and the application scope. In summary, the contents of the present disclosure should not be construed as limitations to the present disclosure.

What is claimed is:

1. A computer-implemented method for finding at least a trace node among logistics nodes in a logistics chain network corresponding to a logistics unit; wherein the logistics chain network is composed of a plurality of logistics routes, and each of the logistics routes is composed of a plurality of logistics nodes connected in a single direction; wherein the method comprises steps of:
obtaining chain network information of the logistics chain network corresponding to the logistics unit from the logistics system, and determining a target analysis domain and one or more confidence nodes of the logistics unit according to the chain network information, wherein the chain network information comprises logistics node information of each of the logistics nodes;
determining one or more fast nodes according to the chain network information, the target analysis domain, and a timeliness level of each of the logistics nodes in the logistics chain network;
determining a predicted logistics route corresponding to the logistics unit according to the chain network information, the target analysis domain, and the one or more confidence nodes; and
determining the trace node corresponding to the logistics unit according to the one or more fast nodes and the predicted logistics route, and providing the trace node to the logistics system.

2. The method of claim 1, wherein the step of determining the one or more fast nodes according to the chain network information, the target analysis domain and the timeliness level of each of the logistics nodes in the logistics chain network comprises:
determining a first sub-chain network according to the chain network information and the target analysis domain; and
determining the one or more fast nodes according to the first sub-chain network and the timeliness level of each of the logistics nodes in the logistics chain network.

3. The method of claim 2, wherein the step of determining the predicted logistics route corresponding to the logistics unit according to the chain network information, the target analysis domain, and the one or more confidence nodes comprises:
determining a second sub-chain network according to the first sub-chain network and the one or more fast nodes; and
determining the predicted logistics route according to the second sub-chain network and the confidence node.

4. The method of claim 3, wherein the step of determining the trace node corresponding to the logistics unit according to the one or more fast nodes and the predicted logistics route comprises:
determining the logistics node located before the one or more fast nodes in the predicted logistics route as the trace node.

5. The method of claim 2, wherein the step of determining the first sub-chain network according to the chain network information and the target analysis domain comprises:
determining a node type of each of the logistics nodes in the logistics chain network according to the chain network information, wherein the node type comprises a start node, an end node, a fork node, a forking start node, and a midway node; and
generating the first sub-chain network according to the start node, the end node, the fork node, and the forking start node.

6. The method of claim 5, wherein the step of determining the one or more fast nodes according to the first sub-chain network and the timeliness level of each of the logistics nodes in the logistics chain network comprises:
determining the forking start node corresponding to the fork node with the highest timeliness level according to the timeliness level of each of the logistics nodes in the first sub-chain network, and setting the forking start node as a fast forking start node;
determining the fork node corresponding to the fast forking start node as the fast forking node, and generating a third sub-chain network according to the start node, the end node, and the fast forking node;
determining an expected time to move the logistics unit from the start node to the end node through each of the fast forking nodes in the third sub-chain network; and
setting the fast forking node corresponding to the minimum expected time as the one or more fast nodes.

7. The method of claim 6, wherein the step of determining the second sub-chain network according to the first sub-chain network and the one or more fast nodes comprises:
removing the fast forking start node and the fast forking node in the first sub-chain network; and
generating the second sub-chain network according to the remaining logistics nodes in the first sub-chain network.

8. The method of claim 7, wherein the step of determining the predicted logistics route according to the second sub-chain network and the one or more confidence nodes comprises:
determining the expected time to move the logistics unit from the start node to the end node through each of the forking nodes in the second sub-chain network; and
generating the predicted logistics route according to the expected time and the one or more confidence nodes.

9. The method of claim 8, wherein the step of generating the predicted logistics route according to the expected time parameter and the one or more confidence nodes comprises:
setting the logistics route with the largest number of confidence nodes as the predicted logistics route, in response to there being logistics routes with the same expected time; and
setting the logistics route with the minimum expected time as the predicted logistics route, in response to there being no logistics route with the same expected time.

10. An apparatus for finding at least a trace node among logistics nodes in a logistics chain network corresponding to a logistics unit; wherein the logistics chain network is composed of a plurality of logistics routes, and each of the logistics routes is composed of a plurality of logistics nodes connected in a single direction; wherein the apparatus comprises:
a memory;
a processor; and
one or more computer programs stored in the memory and executable on the processor, wherein the one or more computer programs comprise:
instructions for obtaining chain network information of the logistics chain network corresponding to the logistics unit from the logistics system, and determining a target analysis domain and one or more confidence node of the logistics unit according to the chain network information, wherein the chain network information comprises logistics node information of each of the logistics nodes;
instructions for determining one or more fast nodes according to the chain network information, the target analysis domain, and a timeliness level of each of the logistics nodes in the logistics chain network;
instructions for determining a predicted logistics route corresponding to the logistics unit according to the chain network information, the target analysis domain, and the one or more confidence nodes; and
instructions for determining the trace node corresponding to the logistics unit according to the one or more fast nodes and the predicted logistics route, and providing the trace node to the logistics system.

11. The apparatus of claim 10, wherein the instructions for determining the one or more fast nodes according to the chain network information, the target analysis domain and the timeliness level of each of the logistics nodes in the logistics chain network comprise:
instructions for determining a first sub-chain network according to the chain network information and the target analysis domain; and
instructions for determining the one or more fast nodes according to the first sub-chain network and the timeliness level of each of the logistics nodes in the logistics chain network.

12. The apparatus of claim 11, wherein the instructions for determining the predicted logistics route corresponding to the logistics unit according to the chain network information, the target analysis domain, and the one or more confidence nodes comprise:
instructions for determining a second sub-chain network according to the first sub-chain network and the one or more fast nodes; and
instructions for determining the predicted logistics route according to the second sub-chain network and the confidence node.

13. The apparatus of claim 12, wherein the instructions for determining the trace node corresponding to the logistics unit according to the one or more fast nodes and the predicted logistics route comprise:
instructions for determining the logistics node located before the one or more fast nodes in the predicted logistics route as the trace node.

14. The apparatus of claim 11, wherein the instructions for determining the first sub-chain network according to the chain network information and the target analysis domain comprise:
instructions for determining a node type of each of the logistics nodes in the logistics chain network according to the chain network information, wherein the node type comprises a start node, an end node, a fork node, a forking start node, and a midway node; and
instructions for generating the first sub-chain network according to the start node, the end node, the fork node, and the forking start node.

15. The apparatus of claim 14, wherein the instructions for determining the one or more fast nodes according to the first sub-chain network and the timeliness level of each of the logistics nodes in the logistics chain network comprise:
instructions for determining the forking start node corresponding to the fork node with the highest timeliness level according to the timeliness level of each of the logistics nodes in the first sub-chain network, and setting the forking start node as a fast forking start node;
instructions for determining the fork node corresponding to the fast forking start node as the fast forking node, and generating a third sub-chain network according to the start node, the end node, and the fast forking node;
instructions for determining an expected time to move the logistics unit from the start node to the end node through each of the fast forking nodes in the third sub-chain network; and
instructions for setting the fast forking node corresponding to the minimum expected time as the fast node.

16. The apparatus of claim 15, wherein the instructions for determining the second sub-chain network according to the first sub-chain network and the one or more fast nodes comprise:
instructions for removing the fast forking start node and the fast forking node in the first sub-chain network; and
instructions for generating the second sub-chain network according to the remaining logistics nodes in the first sub-chain network.

17. The apparatus of claim 16, wherein the instructions for determining the predicted logistics route according to the second sub-chain network and the one or more confidence nodes comprise:
instructions for determining the expected time to move the logistics unit from the start node to the end node through each of the forking nodes in the second sub-chain network; and
instructions for generating the predicted logistics route according to the expected time and the one or more confidence nodes.

18. The apparatus of claim 17, wherein the instructions for generating the predicted logistics route according to the expected time parameter and the one or more confidence nodes comprise:
instructions for setting the logistics route with the largest number of confidence nodes as the predicted logistics route, in response to there being logistics routes with the same expected time; and
instructions for setting the logistics route with the minimum expected time as the predicted logistics route, in response to there being no logistics route with the same expected time.
